(19) United States
(12) Patent Application Publication
(10) Pub. No.: US 2019/0329659 A1
(43) Pub. Date: Oct. 31, 2019

(54) RAILCAR BOGIE

(71) Applicant: KAWASAKI JUKOGYO KABUSHIKI KAISHA, Kobe-shi, Hyogo (JP)

(72) Inventors: Yoshihiro TAMURA, Kobe-shi (JP); Yukitaka TAGA, Kobe-shi (JP); Fumikazu KOUNOIKE, Kakogawa-shi (JP); Takaya ONO, Kobe-shi (JP)

(73) Assignee: KAWASAKI JUKOGYO KABUSHIKI KAISHA, Kobe-shi, Hyogo (JP)

(21) Appl. No.: 16/470,323

(22) PCT Filed: Mar. 14, 2017
(86) PCT No.: PCT/JP2017/010189

§ 371 Date: Jun. 17, 2019

(30) Foreign Application Priority Data
Dec. 16, 2016 (JP) 2016-244556

(51) Int. Cl. B60L 15/40; B61F 5/24; B61F 5/30; B61F 5/50

(52) U.S. Cl. CPC B60L 15/40; B61F 5/50; B61F 5/30; B61F 5/24

(57) ABSTRACT

A railcar bogie includes a link mechanism configured to suppress displacement of an on-board unit attaching portion, the displacement being caused by an operation of a suspension. The link mechanism includes: a first link including the on-board unit attaching portion and a first pivot portion pivotably coupled to an axle box or a member that is displaced integrally with the axle box; and a second link including a second and third pivot portion, the second pivot portion being pivotably coupled to a bogie frame or member that is displaced integrally with the bogie frame, the third pivot portion being pivotably coupled to the first link. The on-board unit attaching portion is arranged at a bogie outer side of a center of an axle in a car longitudinal direction. The second pivot portion is arranged at a bogie middle side of the center of the axle in the car longitudinal direction.

### TECHNICAL FIELD

The present invention relates to a bogie to which an on-board unit of a railcar is attached.

### BACKGROUND ART

On-board units, such as an on-board antenna of an ATS (Automatic Train Stop) device, are mounted on railcars in some cases (see PTL 1, for example). When the on-board antenna of the ATS device receives a control signal from a ground coil provided on the ground, the ATS device calls attention to a driver or automatically brakes a car to stop the car. In order to perform information transmission between the ground coil and the on-board antenna, the distance between the on-board antenna and the ground coil needs to be set appropriately.

### CITATION LIST

### Patent Literature

PTL 1: Japanese Laid-Open Patent Application Publication No. 2014-60841

### SUMMARY OF INVENTION

### Technical Problem

Vertical load transferred from a carbody to a bogie frame fluctuates between empty-car load and full-car load. Therefore, when the on-board unit is attached to a bracket fixed to the bogie frame, the on-board unit is displaced in a vertical direction in accordance with the load fluctuation. Further, when a coupling point where the bracket and the bogie frame are coupled to each other is set far from the on-board unit due to the design of the bogie, the on-board unit easily vibrates. When the bracket is reinforced to be increased in rigidity for the purpose of suppressing the vibration of the on-board unit, the bogie increases in weight.

Further, when the on-board unit is attached to a bracket fixed to an axle box, the on-board unit is displaced in both the vertical direction and a car longitudinal direction. This is because the axle box may be angularly displaced about an axle in accordance with vertical displacement of the bogie frame.

As above, the distance between the on-board unit and a ground facility changes in accordance with the load fluctuation of the carbody between an empty-car state and a full-car state and the vibration generated by traveling. Therefore, the displacement of the on-board unit is desired to fall within a permissible range regardless of the state of the car.

An object of the present invention is to, in a bogie to which an on-board unit is attached, suppress displacement of the on-board unit relative to a ground facility and also suppress vibration of an on-board unit attaching portion while preventing an increase in weight of the bogie.

### Solution to Problem

A railcar bogie according to one aspect of the present invention includes: a bogie frame; an axle box rotatably supporting an axle and coupled to the bogie frame so as to be displaceable relative to the bogie frame and angularly displaceable about the axle; a suspension interposed between the bogie frame and the axle box; and a link mechanism configured to suppress displacement of an on-board unit attaching portion, the displacement being caused by an operation of the suspension. The link mechanism includes: a first link including the on-board unit attaching portion and a first pivot portion, the first pivot portion being pivotably coupled to the axle box or a member that is displaced integrally with the axle box; and a second link including a second pivot portion and a third pivot portion, the second pivot portion being pivotably coupled to the bogie frame or a member that is displaced integrally with the bogie frame, the third pivot portion being pivotably coupled to the first link. The on-board unit attaching portion is arranged at a bogie outer side of a center of the axle in a car longitudinal direction. The second pivot portion is arranged at a bogie middle side of the center of the axle in the car longitudinal direction.

According the above configuration, an on-board unit is attached to the bogie through the link mechanism pivotably coupled to the bogie frame and the axle box. Therefore, when the suspension operates, the link mechanism operates by both the relative displacement between the bogie frame and the axle box and the angular displacement of the axle box. On this account, the configuration capable of suppressing the displacement of the on-board unit attaching portion relative to the ground facility by utilizing mutual interference between the relative displacement between the bogie frame and the axle box and the angular displacement of the axle box as compared to a case where the on-board unit attaching portion is coupled to only one of the bogie frame and the axle box can be easily provided. The on-board unit attaching portion of the link mechanism is located at the bogie outer side, and a coupling point where the link mechanism and the bogie frame (or the member that is displaced integrally with the bogie frame) are coupled to each other is located at the bogie middle side. Further, the first pivot portion is coupled to the axle box located close to the on-board unit attaching portion. Therefore, even when the distance from the coupling point to the on-board unit attaching portion in the link mechanism is long, the vibration of the on-board unit attaching portion is suppressed without the weight increase caused by increasing the rigidity of the link mechanism.

### Advantageous Effects of Invention

According to the present invention, in a bogie to which an on-board unit is attached, displacement of the on-board unit relative to a ground facility is suppressed, and vibration of an on-board unit attaching portion is suppressed while preventing an increase in weight of the bogie.

### BRIEF DESCRIPTION OF DRAWINGS

FIG. 1 is a side view of a bogie of a railcar according to Embodiment 1 when viewed from a car width direction.

FIG. 2 is a perspective view of a first link of a link mechanism of the bogie shown in FIG. 1.

FIGS. 3A to 3C are diagrams for explaining a design procedure of the link mechanism shown in FIG. 1.

FIG. 4 is a side view of the bogie of the railcar according to Embodiment 2 when viewed from the car width direction.

### DESCRIPTION OF EMBODIMENTS

Hereinafter, embodiments will be explained with reference to the drawings. In the following explanation, a direction in which a railcar travels and a carbody extends is defined as a car longitudinal direction, and a lateral direction perpendicular to the car longitudinal direction is defined as a car width direction. The car longitudinal direction is also called a front-rear direction, and the car width direction is also called a left-right direction.

### Embodiment 1

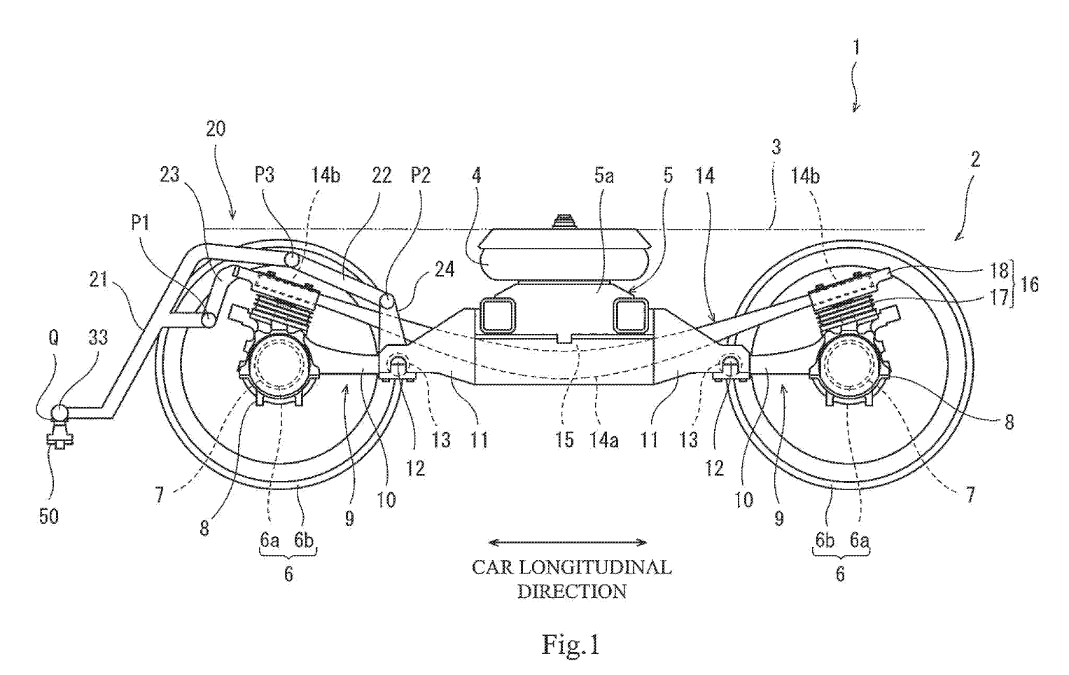

FIG. 1 is a side view of a bogie 2 of a railcar 1 according to Embodiment 1 when viewed from the car width direction. As shown in FIG. 1, the railcar 1 includes the bogie 2 and a carbody 3 supported by the bogie 2 from below. The bogie 2 includes a bogie frame 5. The bogie frame 5 supports the carbody 3 through an air spring 4 that is a secondary suspension. The bogie frame 5 includes a cross beam 5a extending in the car width direction. However, the bogie frame 5 does not include side sills extending in the car longitudinal direction from both respective car width direction end portions of the cross beam 5a. A pair of wheelsets 6 are arranged at both respective car longitudinal direction sides of the cross beam 5a. Each of the wheelsets 6 includes an axle 6a and a pair of wheels 6b. The axle 6a extends in the car width direction. The pair of wheels 6b are provided at both respective car width direction side portions of the axle 6a. Bearings 7 rotatably supporting the axle 6a are provided at both respective car width direction end portions of the axle 6a so as to be located outside the corresponding wheels 6b in the car width direction. The bearings 7 are accommodated in respective axle boxes 8, and with this, the axle boxes 8 rotatably support the axle 6a.

Each car width direction end portion of the cross beam 5a is coupled to the axle boxes 8 through axle beam type axle box suspensions 9. Each of the axle box suspensions 9 includes an axle beam 10. The axle beam 10 extends in the car longitudinal direction from the axle box 8 toward the cross beam 5a. A pair of receiving seats 11 are provided at the bogie frame 5. The pair of receiving seats 11 project from the cross beam 5a toward the axle beam 10 and are spaced apart from each other in the car width direction. The axle beam 10 is elastically coupled to the receiving seats 11. Specifically, the axle beam 10 includes a tubular portion at a tip end thereof. The tubular portion has an axis extending in the car width direction. A core rod 12 is inserted into the tubular portion through an elastic bushing 13 (such as a rubber bushing). Both end portions of the core rod 12 are fixed to the respective receiving seats 11. To be specific, the axle box 8 is coupled to the bogie frame 5 so as to be displaceable relative to the bogie frame 5 by the elastic deformation of the elastic bushing 13 and angularly displaceable about the axle 6a.

Each of plate springs 14 extending in the car longitudinal direction as primary suspensions is interposed between the axle box 8 and the bogie frame 5. The plate spring 14 extends through a space between the pair of receiving seats 11. A longitudinal direction middle portion 14a of the plate spring 14 is arranged lower than both longitudinal direction end portions 14b of the plate spring 14. The plate spring 14 has a bow shape that is convex downward in a side view of the bogie. A pair of axle boxes 8 arranged away from each other in the car longitudinal direction support the respective end portions 14b of the plate spring 14. The middle portions 14a of the plate springs 14 support the respective car width direction end portions of the cross beam 5a from below. With this, the cross beam 5a is supported by the axle boxes 8 through the plate springs 14. To be specific, each of the plate springs 14 has both the function of the primary suspension and the function of a conventional side sill.

The plate spring 14 is made of, for example, fiber-reinforced resin. A pressing member 15 is provided at a lower portion of the car width direction end portion of the cross beam 5a. The pressing member 15 includes a circular-arc lower surface that is convex downward. The pressing member 15 is placed on the middle portion 14a of the plate spring 14 from above so as to separably contact the middle portion 14a. To be specific, the plate spring 14 is not fixed to the pressing member 15 in the upper-lower direction, and the pressing member 15 contacts an upper surface of the plate spring 14 by gravitational downward load from the cross beam 5a. To be specific, the pressing member 15 is not fixed to the plate spring 14 by a fixture, and the contact of the pressing member 15 with the upper surface of the plate spring 14 is kept by contact pressure generated by the gravitational downward load from the cross beam 5a and reaction force of the plate spring 14 with respect to the gravitational downward load.

A spring seat 16 is attached to an upper end portion of each axle box 8. Each end portion 14b of the plate spring 14 is supported by the axle box 8 from below through the spring seat 16. An upper surface of the spring seat 16 is inclined toward a bogie middle side in a bogie side view. The end portion 14b of the plate spring 14 is not fixed to the spring seat 16 in the upper-lower direction and is placed on the spring seat 16 from above. The spring seat 16 includes a base member 17 (such as vibrationproof rubber) and a receiving member 18. The base member 17 is provided on the axle box 8, and the receiving member 18 is provided on and positioned by the base member 17. The receiving member 18 includes a concave portion that is open toward an upper side and the bogie middle side, and the end portion 14b of the plate spring 14 is accommodated in the concave portion.

A link mechanism 20 is provided at the bogie 2. The link mechanism 20 includes an on-board unit attaching portion Q to which an on-board unit 50 is attached. The on-board unit 50 is a unit that receives an action from a ground facility at a predetermined position. In the present embodiment, the on-board unit 50 is, for example, an on-board antenna which is a unit of an ATS (Automatic Train Stop) device or a unit of an ATC (Automatic Train Control) device and can receive a wireless signal from a ground coil at a predetermined position. The link mechanism 20 includes a first link 21 and second links 22 and is configured to suppress the displacement of the on-board unit attaching portion Q when the plate spring 14 elastically deforms.

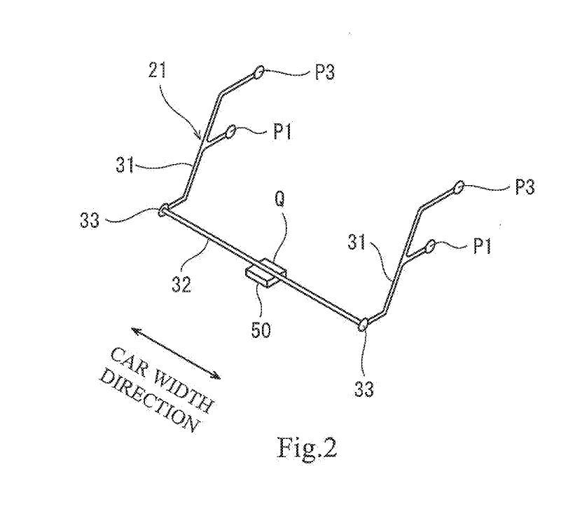

FIG. 2 is a perspective view of the first link 21 of the link mechanism 20 of the bogie 2 shown in FIG. 1. As shown in FIGS. 1 and 2, the first link 21 has a rod shape and includes the on-board unit attaching portion Q and first pivot portions P1. The on-board unit attaching portion Q is a portion to which the on-board unit 50 is fixed by, for example, a fixture. Each of the first pivot portions P1 is pivotably coupled to a member that is displaced integrally with the axle box 8, i.e., a member that rotates simultaneously with and in the same direction as the rotation of the axle box 8 about the axle 6a. In the present embodiment, the first pivot portion P1 is rotatably coupled to a bracket 23 fixed to the spring seat 16 (specifically, the receiving member 18). To be specific, the first link 21 is angularly displaceable relative to the axle boxes 8 about a rotation axis extending in the car width direction at the first pivot portions P1.

In the present embodiment, the first link 21 includes a pair of side link portions 31, a coupling link portion 32, and a pair of elastic connecting portions 33. The pair of side link portions 31 are arranged away from each other in the car width direction. The pair of side link portions 31 are coupled, at the first pivot portions P1, to a pair of spring seats 16 attached to a pair of axle boxes 8 supporting both respective car width direction end portions of the axle 6a. The coupling link portion 32 extends in the car width direction and is interposed between the pair of side link portions 31. Both car width direction end portions of the coupling link portion 32 are flexibly connected to the respective side link portions 31 through the respective elastic connecting portions 33. Each of the elastic connecting portions 33 has a connecting function and an elastic function and is, for example a rubber bushing. The on-board unit attaching portion Q is provided at a car width direction middle portion of the coupling link portion 32. To be specific, the position of the on-board unit attaching portion Q in the car width direction corresponds to the ground coil (not shown) arranged between a pair of rails.

As shown in FIG. 1, each of the second links 22 has a rod shape and includes a second pivot portion P2 and a third pivot portion P3. The second pivot portion P2 is pivotably coupled to a member that is displaced integrally with the bogie frame 5, i.e., a member that moves simultaneously with and in the same direction as the movement of the bogie frame 5 which moves in the upper direction or the lower direction. In the present embodiment, the second pivot portion P2 is rotatably coupled to a bracket 24 fixed to the receiving seats 11 of the bogie frame 5. To be specific, the second link 22 is angularly displaceable relative to the bogie frame 5 about a rotation axis extending in the car width direction at the second pivot portion P2. The third pivot portion P3 is pivotably coupled to the first link 21. To be specific, the first link 21 is coupled to the second links 22 so as to be angularly displaceable relative to the second links 22 about a rotation axis extending in the car width direction at the third pivot portions P3.

The on-board unit attaching portion Q, the first pivot portion P1, the third pivot portion P3, and the second pivot portion P2 are arranged so as to be lined up in this order in the car longitudinal direction from a bogie outer side toward the bogie middle side. The on-board unit attaching portion Q is arranged at the bogie outer side of the center of the axle 6a in the car longitudinal direction. More specifically, the on-board unit attaching portion Q is arranged at an outside of the wheelset 6 in the car longitudinal direction. The first pivot portion P1 is arranged between the on-board unit attaching portion Q and the center of the axle 6a in the car longitudinal direction. The first pivot portion P1 is arranged higher than the center of the axle 6a. The second pivot portion P2 is arranged at the bogie middle side (cross beam 5a side) of the axle 6a in the car longitudinal direction. More specifically, the second pivot portion P2 is arranged at the bogie middle side of the axle box 8. The second pivot portion P2 is arranged higher than the plate spring 14.

The third pivot portion P3 is arranged higher than the first pivot portion P1 and the axle box 8. More specifically, the third pivot portion P3 is arranged higher than the end portion 14b of the plate spring 14. The third pivot portion P3 is arranged at an inside of a car width direction outer end of the axle box 8 in the car width direction. More specifically, when viewed from above, the third pivot portion P3 is arranged so as to overlap the end portion 14b of the plate spring 14 and the axle box 8. The third pivot portion P3 is arranged lower than an upper end of the wheel 6b. To be specific, the entire link mechanism 20 is arranged lower than the upper end of the wheel 6b. It should be noted that when there is a large space between the wheel 6b and the carbody 3, the link mechanism 20 may project higher than the upper end of the wheel 6b.

Next, one example of a design procedure of the link mechanism 20 will be explained.

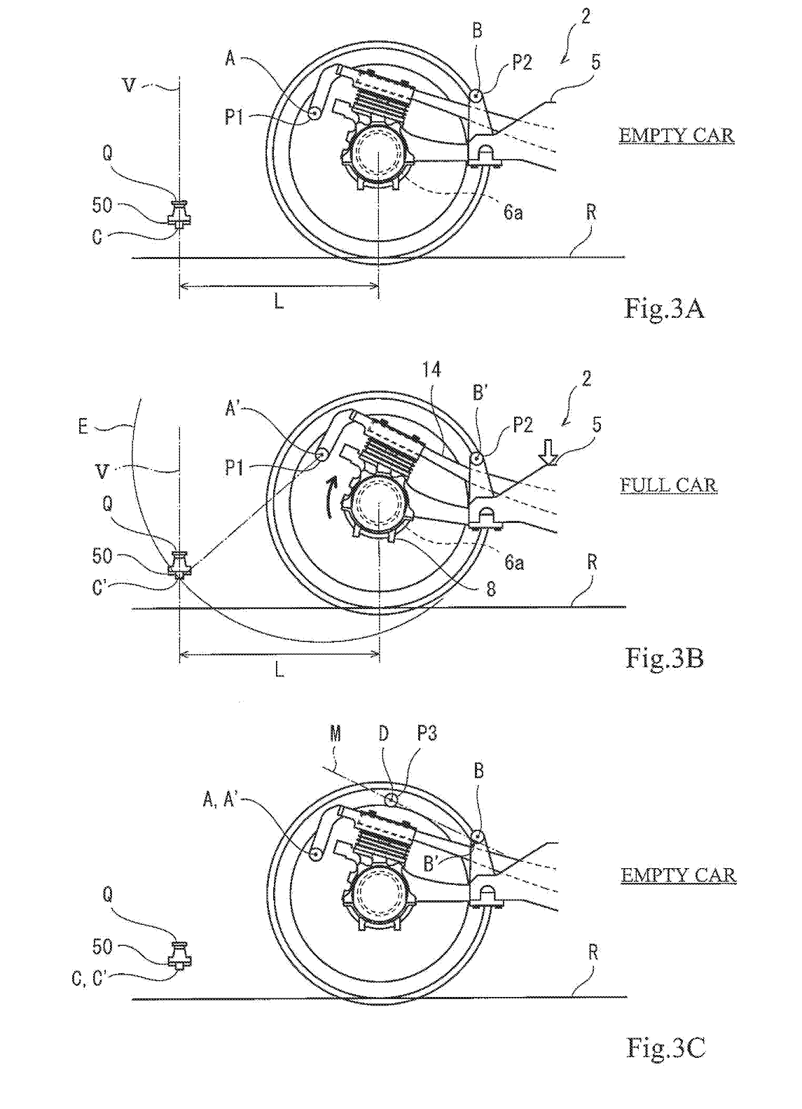

First, as shown in FIG. 3A, the bogie 2 in an empty car state is drawn, i.e., the bogie 2 when vertical load transferred from the carbody 3 (see FIG. 1) to the bogie frame 5 is empty-car load is drawn. In the bogie 2 in the empty car state, the first pivot portion P1 is referred to as a point A, the second pivot portion P2 is referred to as a point B, and a specific position (for example, an antenna tip end position) of the on-board unit 50 attached to the on-board unit attaching portion Q is referred to as a point C. The point A is set to an arbitrary position at the bogie outer side of the center of the axle 6a. The point B is set to an arbitrary position at the bogie middle side of the center of the axle 6a. The point C is set to a predetermined target position of the on-board unit 50 attached to the on-board unit attaching portion Q. In this example, the point C is set such that: a distance L between the point C and the center of the axle 6a in the car longitudinal direction becomes a predetermined value; and a height H of the point C from a rail R becomes a predetermined value. It should be noted that a vertical line passing through the point C is shown by V.

Next, as shown in FIG. 3B, the bogie 2 in a full car state is drawn, i.e., the bogie 2 when the vertical load transferred from the carbody 3 (see FIG. 1) to the bogie frame 5 is full-car load is drawn. According to the bogie 2 in the full car state as compared to the empty car state, the plate spring 14 is bent, and the bogie frame 5 moves downward, and in accordance with this, the axle box 8 rotates about the axle 6a. Therefore, each of the position of the first pivot portion P1 and the position of the second pivot portion P2 changes between the full car state and the empty car state. In the bogie 2 in the full car state, the first pivot portion P1 is referred to as a point A′, the second pivot portion P2 is referred to as a point B′, and the specific position of the on-board unit 50 attached to the on-board unit attaching portion Q is referred to as a point C′.

This example explains a case where the link mechanism 20 is designed such that the position of the point C′ in the car longitudinal direction in the full car state coincides with the position of the point C in the car longitudinal direction in the empty car state. A circle E having the point A′ as the center and a radius equal to the length of a line segment AC is drawn, and an intersection point between the circle E and the vertical line V (a perpendicular line passing through the point C) is set as the point C′ (It should be noted that when designing the link mechanism 20 configured such that the height of the point C′ in the full car state coincides with the height of the point C in the empty car state, an intersection point between the circle E and a horizontal line passing through the point C in the empty car state is only required to be set as the point C′.).

Next, as shown in FIG. 3C, in the bogie 2 in the empty car state, a triangle A′B′C′ is moved such that a line segment A′C′ overlaps the line segment AC, and in this state, a point D as the third pivot portion P3 is set at an arbitrary position on a perpendicular bisector M of a line segment BB′. Thus, all the positions of the points A to D are determined. Then, the shapes of the first link 21 and the second link 22 are determined such that: the point A corresponds to the position of the first pivot portion P1; the point B corresponds to the position of the second pivot portion P2; the point C corresponds to the specific position of the on-board unit 50; and the point D corresponds to the position of the third pivot portion P3.

According to the above-explained configuration, the on-board unit 50 is attached to the bogie 2 through the link mechanism 20 which is pivotably coupled to the bogie frame 5 and the axle box 8. Therefore, when the vertical load transferred from the carbody 3 to the bogie frame 5 fluctuates between the empty-car load and the full-car load, and the plate spring 14 elastically deforms, the link mechanism 20 operates by both the relative displacement between the bogie frame 5 and the axle box 8 and the angular displacement of the axle box 8. On this account, the configuration capable of suppressing the displacement of the on-board unit attaching portion Q relative to the ground facility by utilizing mutual interference between the relative displacement between the bogie frame 5 and the axle box 8 and the angular displacement of the axle box 8 as compared to a case where the on-board unit attaching portion is coupled to only one of the bogie frame 5 and the axle box 8 can be easily provided.

A coupling point (second pivot portion P2) where the link mechanism 20 and the bracket 24 of the bogie frame 5 are coupled to each other is located at the bogie middle side, and the first pivot portion P1 is coupled to the axle box 8 located close to the on-board unit attaching portion Q. Therefore, even when the distance from the second pivot portion P2 to the on-board unit attaching portion Q in the link mechanism 20 is long, the link mechanism 20 is not required to be reinforced. Thus, the vibration of the on-board unit attaching portion Q can be suppressed without increasing the weight of the link mechanism 20.

The on-board unit attaching portion Q is coupled not only to the bogie frame 5 but also to the axle box 8. Therefore, even the bogie 2 from which so-called side sills are omitted and which is provided with the plate springs 14 can stably hold the on-board unit attaching portion Q.

The on-board unit attaching portion Q, the first pivot portion P1, the third pivot portion P3, and the second pivot portion P2 are arranged so as to be lined up in this order in the car longitudinal direction from the bogie outer side toward the bogie middle side. On this account, the first link 21 and the second link 22 constituting the link mechanism 20 are prevented from increasing in length, and therefore, the weight increase and deformation of the link mechanism 20 are suitably prevented.

The third pivot portion P3 is arranged higher than the axle box 8 and at an inside of the car width direction outer end of the axle box 8 in the car width direction. Therefore, the link mechanism 20 is arranged compactly within the range of a car gauge. Further, the first pivot portion P1 is arranged higher than the center of the axle 6a and lower than the third pivot portion P3. Therefore, the strength of the link mechanism 20 is suitably kept within the range of the car gauge.

The first pivot portion P1 of the first link 21 is not coupled to the axle box 8 that directly receives the vibration from the wheelset 6 but is coupled to a member (receiving member 18) arranged such that an elastic member (base member 17) is interposed between the axle box 8 and the member (receiving member 18). Therefore, the effect of suppressing the vibration of the first link 21 is increased. The first link 21 includes the elastic connecting portions 33. Therefore, even when the left and right side link portions 31 are independently displaced, i.e., differently displaced, bending force and twisting force acting on the side link portions 31 and the coupling link portion 32 are reduced.

### Embodiment 2

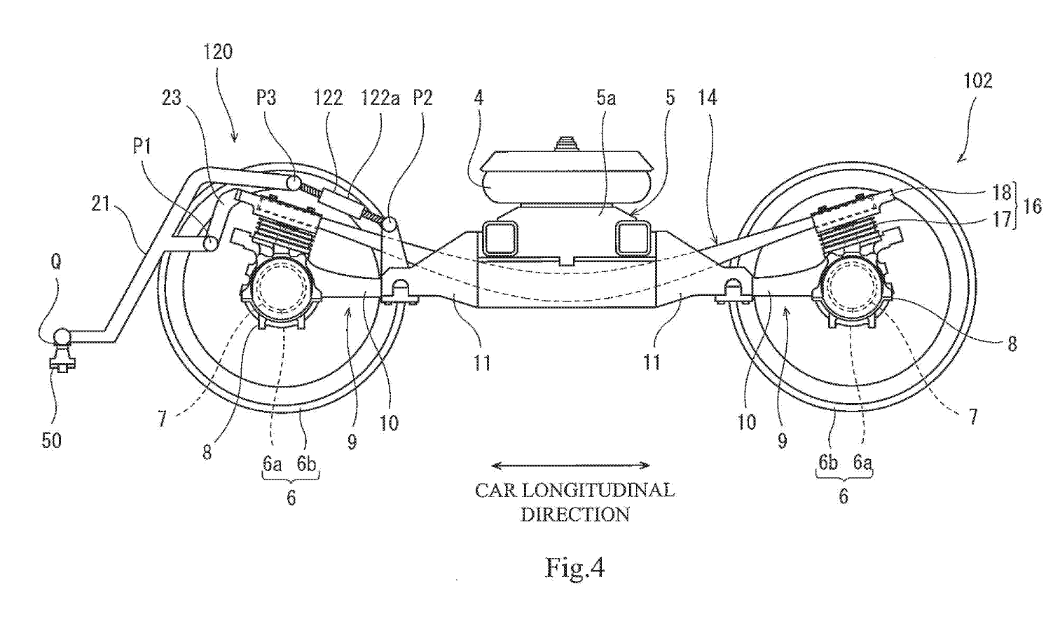

FIG. 4 is a side view of a bogie 102 of the railcar according to Embodiment 2. As shown in FIG. 4, a second link 122 of a link mechanism 120 of the bogie 102 of Embodiment 2 is different from that of Embodiment 1. The second link 122 includes a variable mechanism 122a capable of adjusting the distance between the second pivot portion P2 and the third pivot portion P3. For example, the variable mechanism 122a is a turnbuckle. The second pivot portion P2 is provided at one end portion of the variable mechanism 122a, and the third pivot portion P3 is provided at the other end portion of the variable mechanism 122a. When an operator rotates the turnbuckle as the second link 122, the third pivot portion P3 moves close to or away from the second pivot portion P2, and the first link 21 swings about a fulcrum that is the first pivot portion P1. Thus, the position of the on-board unit attaching portion Q of the first link 21 changes.

According to this configuration, the distance between the second pivot portion P2 and the third pivot portion P3 is adjusted by the variable mechanism 122a. With this, a final position of the on-board unit attaching portion Q is adjusted. Further, since a mechanism configured to adjust the final position of the on-board unit attaching portion Q does not have to be provided in the vicinity of the on-board unit 50, the weight increase of the first link 21 is prevented, and the vibration of the first link 21 is suppressed. It should be noted that since the other components are the same as those of Embodiment 1, explanations thereof are omitted. The variable mechanism may be a component other than the turnbuckle as long as the component can adjust the distance between the second pivot portion P2 and the third pivot portion P3.

The present invention is not limited to the above embodiments, and modifications, additions, and eliminations may be made with respect to the configuration of the present invention. The first link 21 may be coupled to the axle box 8 itself or a member that is displaced integrally with the axle box 8, instead of being coupled to the spring seat 16 at the first pivot portion P1. The second link (22, 122) may be coupled to the bogie frame 5 itself or a member that is displaced integrally with the bogie frame 5, instead of being coupled to the bracket 24 at the second pivot portion P2. When setting the point D, instead of moving the triangle A′B′C′ such that the line segment A′C′ overlaps the line segment AC, the point D may be set on the perpendicular bisector of the line segment BB′ in a state where the triangle A′B′C′ is moved such that the line segment A′C′ approaches the line segment AC in terms of the distance and/or the angle. In the first link, the side link portion 31 and the coupling link portion 32 may be rigidly coupled to each other without providing the elastic connecting portion 33. The on-board unit 50 is not limited to the on-board antenna of the ATS device or ATC device and may be, for example, a trip cock. The bogie is not limited to a bogie including a plate spring as a primary suspension and may be a typical bogie including a coil spring. The axle box suspension is not limited to an axle beam type and may be any type.

### REFERENCE SIGNS LIST

1 railcar
2, 102 bogie
5 bogie frame
5a cross beam
6a axle
8 axle box
14 plate spring (suspension)
16 spring seat
20, 120 link mechanism
21 first link
22, 122 second link
23, 24 bracket
50 on-board unit
122a variable mechanism
P1 first pivot portion
P2 second pivot portion
P3 third pivot portion
Q on-board unit attaching portion

1. A railcar bogie comprising:
a bogie frame;
an axle box rotatably supporting an axle and coupled to the bogie frame so as to be displaceable relative to the bogie frame and angularly displaceable about the axle;
a suspension interposed between the bogie frame and the axle box; and
a link mechanism configured to suppress displacement of an on-board unit attaching portion, the displacement being caused by an operation of the suspension, wherein:
the link mechanism includes
a first link including the on-board unit attaching portion and a first pivot portion, the first pivot portion being pivotably coupled to the axle box or a member that is displaced integrally with the axle box, and
a second link including a second pivot portion and a third pivot portion, the second pivot portion being pivotably coupled to the bogie frame or a member that is displaced integrally with the bogie frame, the third pivot portion being pivotably coupled to the first link;
the on-board unit attaching portion is arranged at a bogie outer side of a center of the axle in a car longitudinal direction; and
the second pivot portion is arranged at a bogie middle side of the center of the axle in the car longitudinal direction.

2. The railcar bogie according to claim 1, wherein the on-board unit attaching portion, the first pivot portion, the third pivot portion, and the second pivot portion are arranged so as to be lined up in this order in the car longitudinal direction from the bogie outer side to the bogie middle side.

3. The railcar bogie according to claim 1, wherein the third pivot portion is arranged higher than the axle box and at an inside of a car width direction outer end of the axle box in a car width direction.

4. The railcar bogie according to claim 1, wherein the first pivot portion is arranged higher than the center of the axle and lower than the third pivot portion.

5. The railcar bogie according to claim 1, wherein:
when vertical load transferred from a carbody to the bogie frame is empty-car load, the first pivot portion is referred to as a point A, the second pivot portion is referred to as a point B, and a predetermined target position of an on-board unit attached to the on-board unit attaching portion is referred to as a point C;
when the vertical load transferred from the carbody to the bogie frame is full-car load, the first pivot portion is referred to as a point A′, and the second pivot portion is referred to as a point B′;
when viewed from a car width direction, a point where a circle having a center at the point A′ and a radius equal to length of a line segment AC intersects with a vertical line passing through the point C or a horizontal line passing through the point C is referred to as a point C′; and
the third pivot portion is set on a perpendicular bisector of a line segment BB′ in a state where a triangle A′B′C′ is moved such that a line segment A′C′ overlaps or approaches the line segment AC.

6. The railcar bogie according to claim 1, wherein the second link includes a variable mechanism configured to adjust a distance between the second pivot portion and the third pivot portion.

7. The railcar bogie according to claim 1, wherein:
the bogie frame includes a cross beam extending in a car width direction; and
the suspension is a plate spring that extends in the car longitudinal direction while supporting a car width direction end portion of the cross beam and is supported by the axle box.
